(19) United States
(12) Patent Application Publication
(10) Pub. No.: US 2018/0338886 A1
(43) Pub. Date: Nov. 29, 2018

(54) SKIN CLEANING APPARATUS

(71) Applicant: SHENZHEN VALUELINK E-COMMERCE CO., LTD., Shenzhen (CN)

(72) Inventor: Qingcao GAN, Shenzhen (CN)

(21) Appl. No.: 15/624,693

(22) Filed: Jun. 15, 2017

(30) Foreign Application Priority Data
May 23, 2017 (CN) 201710369446.5

(51) Int. Cl. A61H 23/02; A61H 7/00; B05B 17/06

(52) U.S. Cl. CPC A61H 23/0245; A61H 7/005; A45D 2200/1054; A61H 2201/5097; A45D 2200/207; B05B 17/063

(57) ABSTRACT

The present invention relates to a skin care device, and in particular relates to a skin cleaning apparatus including a shell, a cleaning part arranged at the outer side of the shell and used for cleaning skin, a power part arranged in the shell and used for driving the cleaning part to work, a box body arranged in the shell, and an atomizer connected with the box body; and the shell is provided with a spray port for the atomizer to spray. The skin cleaning apparatus of the structure is simple in structure, convenient to use, difficult to injure the skin, and high in user experience.

### TECHNICAL FIELD

The present invention relates to a skin care device, and in particular relates to a skin cleaning apparatus.

### BACKGROUND

Some parts (such as feet, hands and the like) of a human body are likely to produce cutin. If the cutin is not removed, the health of foot skin may be affected, and an appearance of the human body may also be affected.

A great number of apparatuses for removing dead skin cells, calluses and the like on a surface of the foot skin appear in the market. A basic structure of the apparatus is that a micro motor is installed in a housing, and a foot grinding head is fixedly installed on an output end of a motor shaft of the motor; and when the motor is operated, the motor drives the foot grinding head to rotate through the motor shaft, and the foot grinding head is aligned with a to-be-ground part of a foot so as to achieve a purpose of cleaning the foot skin. However, in the process of cleaning the foot skin by the foregoing apparatuses, a great amount of skin crumbs may be produced, resulting in flying of the skin crumbs and greatly influencing an application environment. Moreover, when the skin is always ground by the foot grinding head, the skin is very dry and is easily injured, and a peculiar smell is easy to produce.

### SUMMARY

In order to solve the above defects of the prior art, an objective of the present invention is to provide a skin cleaning apparatus which is convenient to use, difficult to injure the skin and has high user experience.

In order to achieve the above objective, a technical solution of the present invention is as follows:

A skin cleaning apparatus includes a shell, a cleaning part arranged at the outer side of the shell and used for cleaning skin, a power part arranged in the shell and used for driving the cleaning part to work, a box body arranged in the shell, and an atomizer connected with the box body; and the shell is provided with a spray port for the atomizer to spray.

The skin cleaning apparatus of the above structure is simple in structure and convenient to operate. In particular, the atomizer is arranged in the shell, so that when the skin cleaning apparatus cleans the skin, atomized liquid sprayed from the spray port can first wet a portion to be cleaned, and then the cleaning part cleans the skin, or simultaneously wets and cleans the skin. In either way, the portion to be cleaned is wet, so that the skin is not dry, and when in cleaning, an injury risk of the skin can be greatly reduced; and meanwhile, when in cleaning, a flying phenomenon of the skin crumbs can be avoided, and the user experience is improved.

Further, in order to simplify the structure and facilitate the installation, the cleaning part is a friction wheel; the power part includes a motor and a rotating shaft connected with a motor shaft of the motor in a transmission manner; and the friction wheel is driven by the rotating shaft to rotate. A transmission manner of the rotating shaft and the motor shaft may employ a gear transmission mode, may also employ a belt transmission mode and may further employ a chain transmission mode.

Further, in order to simplify the structure and facilitate the processing and installation, the rotating shaft includes a left shaft and a right shaft; the left end of the left shaft is arranged in the shell in a rotating manner through a left bearing, and the right end is connected with the friction wheel; and the left end of the right shaft is connected with the friction wheel, the right end is connected with a right bearing, and the right bearing is connected with the motor shaft of the motor in a transmission manner.

Further, in order to replace the friction wheel, the friction wheel is transversely arranged on the left shaft and the right shaft in a sliding manner; the left bearing is clamped and fixed at the shell; the left end of the left shaft is arranged at the left bearing in a rotating manner, and the right end is provided with a left ejector pin; the left end of the right shaft is provided with a right ejector pin, the right ejector pin is connected with an elastic part, and the other end of the elastic part is abutted against the friction wheel of the cleaning part; two end surfaces of the friction wheel of the cleaning part are respectively provided with an installing groove for installing the left ejector pin and the right ejector pin; and the outer side of the shell is provided with a button for releasing a clamping state of the left bearing and the shell.

When the entire cleaning apparatus is completely assembled, the friction wheel is transversely arranged on the left shaft and the right shaft in a sliding manner, and the elastic part is abutted against the interior of one installing groove and is in a compressed state; and when the friction wheel needs to be replaced, only the button needs to be pressed, the left shaft is not clamped and fixed to the shell, the friction wheel is separated by the elastic part from the right shaft under a restoration elastic force of the elastic part, and the left shaft is also pushed to be away from the right shaft, so that the friction wheel is separated from the left shaft and the right shaft, and finally other friction wheels can be installed.

Further, in order to simplify the structure and facilitate the processing and installation, the elastic part is a leaf spring.

Further, in order to simplify the structure and facilitate the processing and installation, the elastic part is a spring.

Further, in order to simplify the structure and facilitate the installation, the spring is sleeved on the right ejector pin; or the right ejector pin is provided with an installation hole for accommodating the spring.

Further, in order to simplify the structure and facilitate the installation, the atomizer is an ultrasonic atomizer.

Further, in order to facilitate the handhold of the apparatus for cleaning the skin, the shell includes a handle with a cavity inside, and an upper shell fixedly arranged at the upper end of the handle; the cleaning part is arranged at the outer side of the upper shell; the power part is arranged in the upper shell; the box body is arranged in the handle; and the spray port is arranged at the upper shell and is adjacent to a grinding part.

Further, storage batteries, and a control circuit board electrically connected with the power part and the atomizer are also arranged in the shell; and the outer side of the shell is provided with a control button for controlling the power part and the atomizer, and a protection shell for protecting the cleaning part. The number of the control button may be one so that the control button simultaneously controls the work of the atomizer and the power part, and may also be two so that the two control button respectively controls the work of the atomizer and the power part.

The present invention further provides an application method of the skin cleaning apparatus, which includes the following steps:

preparing the skin cleaning apparatus according to any one of claims 1 to 8;

fully filling the box body with water; and

starting the atomizer and/or power part, wherein the atomizer and the cleaning part are operated simultaneously, or any one of the atomizer and the cleaning part is operated, or any one of the atomizer and the cleaning part is operated prior to the other one.

The application method of the skin cleaning apparatus employs the foregoing skin cleaning apparatus, so that the operation is very convenient; in particular, when the skin cuticle is excessively hard, the atomizer atomizes the water and sprays out the mist from the spray port, after the skin is softened, the power part is started to drive the cleaning part to begin to work, so that when the skin is cleaned, the skin is difficult to injure; when the skin cuticle is not hard, only the power part can be started, and the atomizer is not started; if a user does not rub the skin and only wants to spray mist to the skin, only the atomizer can be started, and the power part is not started; and an operating mode for the user is diversified, and multiple functions are provided for the user, so that the user experience is high.

Further, the cleaning part is the friction wheel, and a rotation speed of the friction wheel is 180 to 240 rpm; a diameter of the spray port is 9 to 11 um; and when the atomizer atomizes the water and sprays out the mist from the spray port, if the atomizer is 25 to 35 mm away from an application surface, a radius of formed mist is 15 to 25 mm.

When the above-mentioned skin cleaning apparatus is used, the skin cleaning apparatus is 25 to 35 mm away from the skin to be cleaned; after the water is atomized by the atomizer, the mist is sprayed to the skin to be cleaned from the spray port with the diameter of 9 to 11 um, and the mist forms a circular area with a radius of 15 to 25 mm; when the atomizer and the power part are simultaneously started, the cleaning part is driven by the power part with the rotation speed of 180 to 240 rpm to rub and clean the skin; and an epidermal layer of the skin is appropriately softened by the mist, so that the cleaning of the cleaning part is facilitated, the deep skin is not easily injured, and the flying phenomenon of the skin crumbs can also be avoided.

The present invention is further described below in combination with drawings and specific embodiments.

### BRIEF DESCRIPTION OF DRAWINGS

FIG. 1 is a structural schematic diagram of a specific embodiment of a skin cleaning apparatus of the present invention (a protection shell is separated from a shell).

FIG. 2 is a sectional view of a specific embodiment of a skin cleaning apparatus of the present invention (a protection shell covers a shell).

FIG. 3 is an exploded structural schematic diagram I of a specific embodiment of a skin cleaning apparatus of the present invention.

FIG. 4 is an exploded structural schematic diagram II of a specific embodiment of a skin cleaning apparatus of the present invention.

### LIST OF REFERENCE NUMERALS

10: shell; 11: spray port

12: handle; 13: upper shell

14: control button; 15: protection shell

16: button; 20: cleaning part

30: power part; 31: motor

32: rotating shaft; 321: left shaft

322: right shaft; 323: left ejector pin

324: right ejector pin; 325: elastic part

326: installing groove; 33: left bearing

34: right bearing; 35: gear

40: box body; 50: atomizer

60: storage battery

### DETAILED DESCRIPTION

In order to more sufficiently understand the technical content of the present invention, the technical solution of the present invention is further introduced and explained below in combination with specific embodiments, but is not limited thereto.

### Embodiments

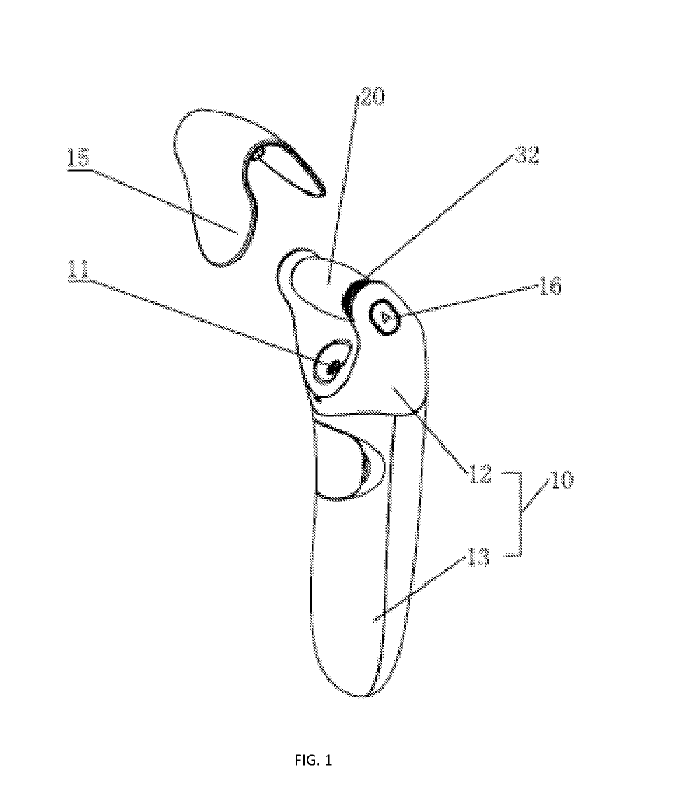

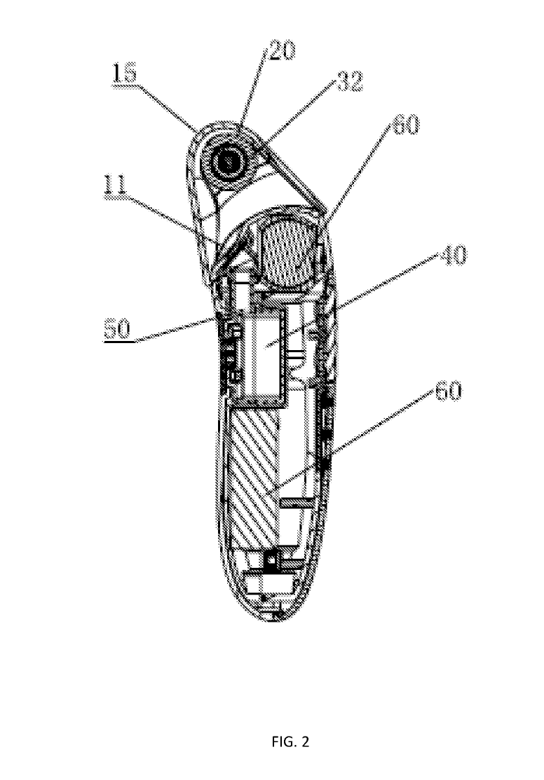

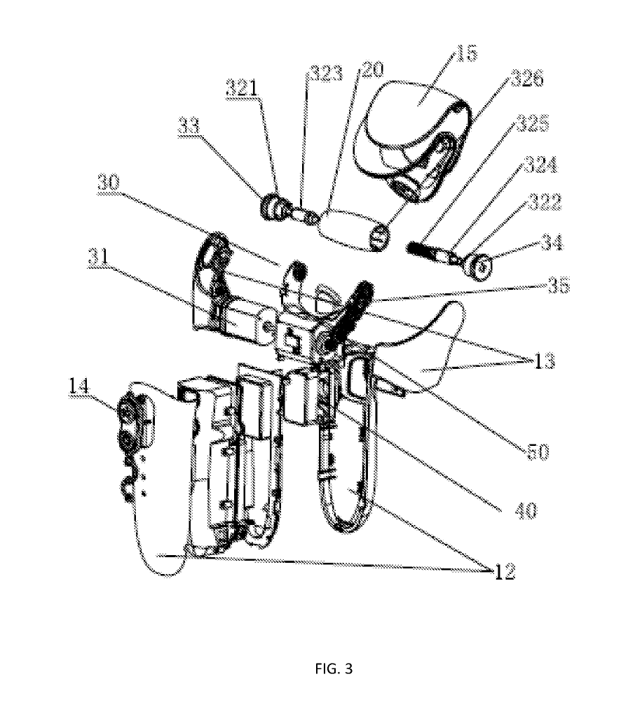

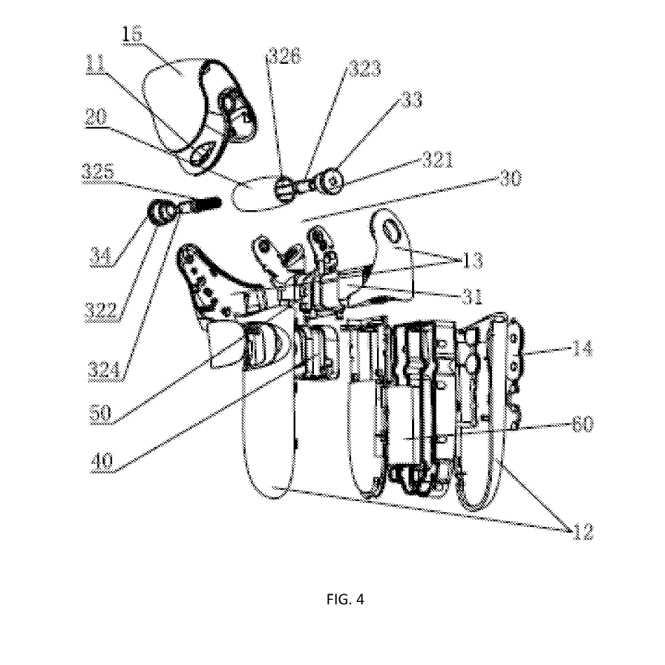

As shown in FIG. 1 to FIG. 4, a skin cleaning apparatus is specifically used for cleaning feet, and includes a shell 10, a cleaning part 20 arranged at the outer side of the shell 10 and used for cleaning skin, a power part 30 arranged in the shell 10 and used for driving the cleaning part 20 to work, a box body 40 arranged in the shell 10, and an atomizer 50 connected with the box body 40; and the shell 10 is provided with a spray port 11 for the atomizer 50 to spray.

Specifically, in other embodiments, the shell 10 includes a handle 12 with a cavity inside, and an upper shell 13 fixedly arranged at the upper end of the handle 12; the cleaning part 20 is arranged at the outer side of the upper shell 13; the power part 30 is arranged in the upper shell 13; the box body 40 is arranged in the handle 12; and the spray port 11 is arranged at the upper shell 13 and is adjacent to a grinding part 20.

Specifically, in other embodiments, the atomizer 50 is an ultrasonic atomizer (may also be an atomizer of other structural principles); the cleaning part 20 is a friction wheel; the power part 30 includes a motor 31, and a rotating shaft 32 connected with a motor shaft of the motor 31 in a transmission manner; and the friction wheel is driven by the rotating shaft 32 to rotate.

Specifically, in other embodiments, two storage batteries 60 and a control circuit board (not shown) electrically connected with the power part 30 and the atomizer 50 are also arranged in the shell 10; and the outer side of the shell 10 is provided with a control button 14 for controlling the power part 30 and the atomizer 50, and a protection shell 15 for protecting the cleaning part 20 (i.e. the friction wheel). Of course, the atomizer 50 and the cleaning part 20 can share one control assembly, and may also be respectively provided with a control assembly.

Further, in other embodiments, the rotating shaft 32 includes a left shaft 321 and a right shaft 322; the left end of the left shaft 321 is arranged in the shell 10 in a rotating manner through a left bearing 33, and the right end is connected with the cleaning part 20 (i.e. the friction wheel); and the left end of the right shaft 322 is connected with the cleaning part 20 (i.e. the friction wheel), the right end is connected with a right bearing 34, and the right bearing 34 is connected with the motor shaft of the motor 31 in a transmission manner through a gear 35 (of course other transmission manners may also be employed).

Further, in other embodiments, the cleaning part 20 (i.e. the friction wheel) is transversely arranged on the left shaft 321 and the right shaft 322 in a sliding manner; the left bearing 33 is clamped and fixed at the shell 10; the left end of the left shaft 321 is arranged at the left bearing 33 in a rotating manner, and the right end is provided with a left ejector pin 323; the left end of the right shaft 322 is provided with a right ejector pin 324, the right ejector pin 324 is connected with an elastic part 325, and the other end of the elastic part 325 is abutted against the cleaning part 20 (i.e. the friction wheel); two end surfaces of the cleaning part 20 (i.e. the friction wheel) are respectively provided with an installing groove 326 for installing the left ejector pin 323 and the right ejector pin 324; and the outer side of the shell 10 is provided with a button 16 for releasing a clamping and fixing state of the left bearing 33 and the shell 10.

Specifically, the elastic part 325 is a leaf spring or a spring; when the elastic part 325 is a spring, the spring is sleeved on the right ejector pin 324; or the right ejector pin 324 is provided with an installing hole for accommodating the spring.

In conclusion, the skin cleaning apparatus of the above structure is simple in structure and convenient to operate; in particular, the atomizer 50 is arranged in the shell 10, so that when cleaning the skin, atomized liquid sprayed from the spray port 11 can first wet a portion to be cleaned, and then the cleaning part 20 cleans the skin, or simultaneously wets and cleans the skin; in either way, the portion to be cleaned is wet, so that the skin is not dry, and when in cleaning, the injury risk of the skin can be greatly reduced; meanwhile, when in cleaning, the flying phenomenon of the skin crumbs can be avoided, and the user experience is improved; and moreover, the cleaning part 20 (i.e. the friction wheel) can be replaced, and the cleaning part 20 (i.e. the friction wheel) of different roughness can be replaced according to the skin at different positions, thereby greatly facilitating the skin protection.

The present invention further provides an application method of the skin cleaning apparatus, which includes the following steps:

the skin cleaning apparatus is well prepared;

the box body 40 is fully filled with water, then the atomizer 50 is started, and then the power part 30 is started; or the atomizer 50 and the power part 30 are simultaneously started;

the atomizer 50 atomizes water and sprays out the mist from the mist spray port 11, and the cleaning part 20 begins to work 3 to 5 minutes later; and further, a rotation speed of the power part 30 (i.e. the motor 31) is 180 to 240 rpm; a diameter of the mist spray port 11 is 9 to 11 micrometers; and when the atomizer 50 atomizes the water and sprays out the mist from the mist spray port 11, if the atomizer is 25 to 35 mm away from an application surface, a formed mist radius is 15 to 25 mm.

In conclusion, the application method of the skin cleaning apparatus employs the foregoing skin cleaning apparatus, so that the operation is convenient; in particular, when the skin cuticle is excessively hard, the atomizer 50 atomizes the water and sprays out the mist from the mist spray port 11; after the skin is softened, the power part 30 is started to drive the cleaning part 20 to begin to work, so that when the skin is cleaned, the skin is difficult to injure; when the skin cuticle is not hard, only the power part 20 can be started, and the atomizer 50 is not started; if a user does not rub the skin and only wants to spray mist to the skin, only the atomizer 50 can be started, and the power part 30 is not started; and the operating mode for the user is diversified, and multiple functions are provided for the user, so that the user experience is high.

When the above-mentioned skin cleaning apparatus is used, the skin cleaning apparatus is 25 to 35 mm away from the skin to be cleaned; after the water is atomized by the atomizer 50, the mist is sprayed to the skin to be cleaned from the mist spray port 11 with the diameter of 9 to 11 micrometers, and the mist forms a circular area with a radius of 15 to 25 mm; when the atomizer 50 and the power part 30 are simultaneously started, the cleaning part 20 is driven by the power part 30 with the rotation speed of 180 to 240 rpm to rub and clean the skin; and an epidermal layer of the skin is appropriately softened by the mist, so that the cleaning of the cleaning part 20 is facilitated, the deep skin is not easily injured, and the flying phenomenon of the skin crumbs can be avoided.

The above embodiments are only used to further explain the technical content of the present invention so as to facilitate easier understanding of a reader, but the embodiments of the present invention are not limited thereto. Any technical extension or recreation made according to the present invention shall be protected by the present invention. The protection scope of the present invention is defined by the claims.

1. A skin cleaning apparatus, comprising a shell, a cleaning part arranged at the outer side of the shell and used for cleaning skin, a power part arranged in the shell and used for driving the cleaning part to work, a box body arranged in the shell, and an atomizer connected with the box body; and the shell is provided with a spray port for the atomizer to spray.

2. The skin cleaning apparatus according to claim 1, wherein the cleaning part is a friction wheel; the power part comprises a motor and a rotating shaft connected with a motor shaft of the motor in a transmission manner; and the friction wheel is driven by the rotating shaft to rotate.

3. The skin cleaning apparatus according to claim 2, wherein the rotating shaft comprises a left shaft and a right shaft; the left end of the left shaft is arranged in the shell in a rotating manner through a left bearing, and the right end is connected with the friction wheel; and the left end of the right shaft is connected with the friction wheel, the right end is connected with a right hearing, and the right bearing is connected with the motor shaft of the motor in a transmission manner.

4. The skin cleaning apparatus according to claim 3, wherein the friction wheel is transversely arranged on the left shaft and the right shaft in a sliding manner; the left bearing is clamped and fixed at the shell; the left end of the left shaft is arranged at the left bearing in a rotating manner, and the right end is provided with a left ejector pin; the left end of the right shaft is provided with aright ejector pin, the right ejector pin is connected with an elastic part, and the other end of the elastic part is abutted against the friction wheel; two end surfaces of the friction wheel are respectively provided with an installing groove for installing the left ejector pin and the right ejector pin; and the outer side of the shell is provided with a button for releasing a clamping state of the left bearing and the shell.

5. The skin cleaning apparatus according to claim 4, wherein the elastic part is a leaf spring or the elastic part is a spring;
when the elastic part is the spring, the spring is sleeved on the right ejector pin; or the right ejector pin is provided with an installation hole for accommodating the spring.

6. The skin cleaning apparatus according to claim 1, wherein the, atomizer is an ultrasonic atomizer.

7. The skin cleaning apparatus according to claim 1, wherein the shell comprises a handle with a cavity inside, and an upper shell fixedly arranged at the upper end of the handle; the cleaning part is arranged at the outer side of the upper shell; the power part is arranged in the upper shell; the box body is arranged in the handle; and the spray port is arranged at the upper shell and is adjacent to a grinding part.

8. The skin cleaning apparatus according to claim 1, wherein storage batteries, and a control circuit board electrically connected with the power part and the atomizer are also arranged in the shell; and the outer side of the shell is provided with a control button for controlling the power part and the atomizer, and a protection shell for protecting the cleaning part.

9. An application method of the skin cleaning apparatus, comprising the following steps:
preparing the skin cleaning apparatus according to claim 1;
fully filling the box body with water; and
starting the atomizer and/or power part, wherein the atomizer and the cleaning part are operated simultaneously, or any one of the atomizer and the cleaning part is operated, or any one of the atomizer and the cleaning part is operated prior to the other one.

10. The application method of the skin cleaning apparatus according to claim 9, wherein a rotation speed of the friction wheel is 180 to 240 rpm; a diameter of the mist spray port is 9 to 11 um; and when the atomizer atomizes the water, sprays out the mist from the mist spray port, and is 25 to 35 mm away from an application surface, a radius of formed mist is 15 to 25 mm.
